(19) United States
(12) Patent Application Publication
(10) Pub. No.: US 2025/0310906 A1
(43) Pub. Date: Oct. 2, 2025

(54) EXTENDED REALITY AND MEDIA SERVICE PROCESSING METHODS AND APPARATUSES, AND COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yang SHEN, Beijing (CN); Yuxin MAO, Beijing (CN)

(73) Assignee: Beijing Xiaomi Mobile Software Co., Ltd., Beijing (CN)

(21) Appl. No.: 18/863,528

(22) PCT Filed: May 13, 2022
(86) PCT No.: PCT/CN2022/092894

§ 371 Date: Nov. 6, 2024

(51) Int. Cl. H04W 56/00; H04L 12/14; H04W 28/02

(52) U.S. Cl. CPC H04W 56/0015; H04L 12/1407; H04W 28/0268

(57) ABSTRACT

An extended reality and media (XRM) service processing method, performed by a time-sensitive communication and time synchronization function (TSCTSF), includes: receiving a session creation request from an application function (AF), where the session creation request includes a synchronization indication and an XRM group identifier; and sending the synchronization indication and the XRM group identifier to a policy control function (PCF).

### TECHNICAL FIELD

This disclosure relates to the field of wireless communication technology, but is not limited thereto, and particularly relates to extended reality and media (XRM) service methods and apparatuses, a communication device and a storage medium.

### BACKGROUND

Extended reality (XR) services include mobile media services, augmented reality (AR), virtual reality (VR), cloud games, video-based machine or drone remote control services, and the like.

XR service involves multimodal data flow. Multimodal data refers to the input data or output data of a single device or different devices corresponding to a single service or application.

Each data flow in multimodal data often has a certain or even strong correlation, such as the synchronization of audio stream and video stream, the synchronization of tactile data and visual data, and the like. There are some common characteristics in the data flows themselves of this type of media service, among respective data flows, and in the network transmission requirements of these service data flows. The effective identification and utilization of these characteristics will be more conducive to the transmission and control of networks and services, thereby being more conducive to service security and user experience.

### SUMMARY

Embodiments of this disclosure provide XRM information processing methods and apparatuses, a communication device and a storage medium.

A first aspect of embodiments of this disclosure provides an XRM service processing method, which is performed by a time-sensitive communication and time synchronization function (TSCTSF) and includes:
receiving a session creation request from an application function (AF), wherein the session creation request includes a synchronization indication and an XRM group identifier; and
sending the synchronization indication and the XRM group identifier to a policy control function (PCF).

A second aspect of embodiments of this disclosure provides an information processing method, which is performed by a PCF and includes:
receiving a synchronization indication and an XRM group identifier sent by a TSCTSF; and
generating a policy control and charging (PCC) rule or activating a predefined PCC rule according to the synchronization indication and the XRM group identifier.

A third aspect of embodiments of this disclosure provides an information processing method, which is performed by an AF and includes:
sending a session creation request of the AF, wherein the session creation request includes a synchronization indication and an XRM group identifier; and
receiving a session creation response corresponding to the session creation request.

A fourth aspect of embodiments of this disclosure provides an information processing method, which is performed by a network exposure function (NEF) and includes:
receiving a session creation request from an AF, wherein the session creation request includes a synchronization indication and an XRM group identifier;
obtaining an address of a TSCTSF receiving the session creation request; and sending the session creation request to the TSCTSF according to the address of the TSCTSF.

A fifth aspect of embodiments of this disclosure provides an XRM service processing apparatus, including:
a first receiving module, configured to receive a session creation request from an AF, wherein the session creation request includes a synchronization indication and an XRM group identifier; and
a first sending module, configured to send the synchronization indication and the XRM group identifier to a PCF.

A sixth aspect of embodiments of this disclosure provides an information processing apparatus, including:
a second receiving module, configured to receive a synchronization indication and an XRM group identifier sent by a TSCTSF; and
a PCC rule module, configured to generate a PCC rule or activate a predefined PCC rule according to the synchronization indication and the XRM group identifier.

A seventh aspect of embodiments of this disclosure provides an information processing apparatus, including:
a third sending module, configured to send a session creation request of an AF, wherein the session creation request includes a synchronization indication and an XRM group identifier; and
a third receiving module, configured to receive a session creation response corresponding to the session creation request.

An eighth aspect of embodiments of this disclosure provides an information processing apparatus, including:
a fourth receiving module, configured to receive a session creation request from an AF, wherein the session creation request includes a synchronization indication and an XRM group identifier;
an obtaining module, configured to obtain an address of TSCTSF receiving the session creation request; and
a fourth sending module, configured to send the session creation request to the TSCTSF according to the address of the TSCTSF.

A ninth aspect of embodiments of this disclosure provides a communication device, including a processor, a transceiver, a memory, and an executable program stored in the memory and able to be executable by the processor, wherein the processor, upon running the executable program, is configured to implement the information processing method according to any one of the first to fourth aspect described above.

A tenth aspect of embodiments of this disclosure provides a computer storage medium storing an executable program thereon, wherein the executable program is used for, upon being executed by a processor, implementing the information processing method according to any one of the first to fourth aspect described above.

Based on the technical solution according to some embodiments of this disclosure, TSCTSF receives the session creation request for XRM service, where the session creation request includes a synchronization indication and an XRM group identifier that can be used by PCF to generate a PCC rule or activate a predefined PCC rule. In this way, TSCTSF treats one or more data flows involved with the session request as a TSC data flow to be strictly synchronized and delay controlled, thereby alleviating the phenomenon of great delay and/or delay difference for one or more data flows involved with the XRM service, and improving service quality of the XRM service.

It should be understood that the above general description and the following detailed description are only exemplary and explanatory, and do not limit the embodiments of this disclosure.

### BRIEF DESCRIPTION OF THE DRAWINGS

The accompanying drawings, which are incorporated in and constitute a part of this specification, illustrate embodiments consistent with the invention and together with the description serve to explain the principles of the embodiments of the invention.

FIG. 1 is a schematic structural diagram of a wireless communication system according to an exemplary embodiment.

FIG. 2 is a schematic flowchart of an information processing method according to an exemplary embodiment.

FIG. 3 is a schematic flowchart of an information processing method according to an exemplary embodiment.

FIG. 4 is a schematic flowchart of an information processing method according to an exemplary embodiment.

FIG. 5 is a schematic flowchart of an information processing method according to an exemplary embodiment.

FIG. 6 is a schematic flowchart of an information processing method according to an exemplary embodiment.

FIG. 7 is a schematic flowchart of an information processing method according to an exemplary embodiment.

FIG. 8 is a schematic flowchart of an information processing method according to an exemplary embodiment.

FIG. 9 is a schematic structural diagram of an information processing apparatus according to an exemplary embodiment.

FIG. 10 is a schematic structural diagram of an information processing apparatus according to an exemplary embodiment.

FIG. 11 is a schematic structural diagram of an information processing apparatus according to an exemplary embodiment.

FIG. 12 is a schematic structural diagram of an information processing apparatus according to an exemplary embodiment.

FIG. 13 is a schematic structural diagram of a UE according to an exemplary embodiment.

FIG. 14 is a schematic structural diagram of a communication device according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of this disclosure. Rather, they are merely examples of apparatuses and methods consistent with some aspects of embodiments of this disclosure.

The terminology used in the embodiments of this disclosure is for the purpose of describing specific embodiments only and is not intended to limit the embodiments of this disclosure. As used in the embodiments of this disclosure and the appended claims, the singular forms “a”, “an” and “the” are intended to include the plural forms as well, unless the context clearly dictates otherwise. It will also be understood that the term “and/or” as used herein refers to and includes any and all possible combinations of one or more of the associated listed items.

It should be understood that although the terms “first”, “second”, “third”, etc. may be used to describe various information in the embodiments of this disclosure, the information should not be limited to these terms. These terms are only used to distinguish information of the same type from each other. For example, without departing from the scope of the embodiments of this disclosure, the first information may also be called second information, and similarly, the second information may also be called first information. Depending on the context, the word “if” as used herein may be interpreted as “when” or “while” or “in response to determining that . . . .”

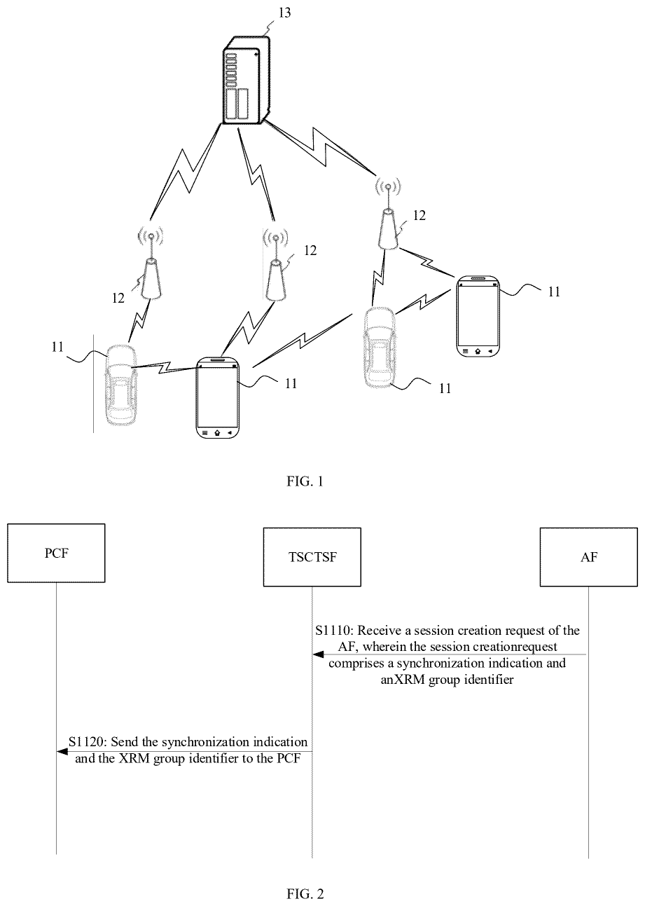

Referring to FIG. 1, which shows a schematic structural diagram of a wireless communication system according to an embodiment of this disclosure. As shown in FIG. 1, the wireless communication system is a communication system based on cellular mobile communication technology, and the wireless communication system may include: several UEs 11 and several access devices 12.

In some embodiments, UE 11 may be a device that provides voice and/or data connectivity to the user. UE 11 can communicate with one or more core networks via a radio access network (RAN), and UE 11 can be an Internet of things (IoT) UE, such as a sensor device, a mobile phone (or called “cellular” phone), and a computer with an IoT UE. For example, it may be a fixed, portable, pocket, hand-held, computer built-in, or vehicle-mounted device, such as station (STA), subscriber unit, subscriber station, mobile station, mobile, remote station, access point, remote terminal, access terminal, user terminal, user agent, user device, or user equipment. Alternatively, UE 11 may also be equipment of an unmanned aerial vehicle. Alternatively, UE 11 may also be a vehicle-mounted device, for example, a trip computer with a wireless communication function, or a wireless user device connected externally to the trip computer. Alternatively, UE 11 may also be a roadside device, for example, a street lamp, a signal lamp, or other roadside devices with a wireless communication function.

The access device 12 may be a network side device in the wireless communication system. In some embodiments, the wireless communication system may be the 4th generation mobile communication (4G) system, also known as the Long Term Evolution (LTE) system. Alternatively, the wireless communication system may also be the 5G system, also known as new radio (NR) system or 5G NR system. Alternatively, the wireless communication system may also be a next-generation system of the 5G system. In some embodiments, the access network in the 5G system can be called NG-RAN (New Generation-Radio Access Network). Alternatively, it may be a machine type communication (MTC) system.

In some embodiments, the access device 12 may be an evolved node-B (eNB) adopted in the 4G system. Alternatively, the access device 12 may also be a gNB adopting a centralization-distributed architecture in the 5G system. When the access device 12 adopts the centralization-distributed architecture, it generally includes a central unit (CU) and at least two distributed units (DUs). The CU is provided with a packet data convergence protocol (PDCP) layer, a radio link layer (RLC) protocol layer, a media access control (MAC) layer protocol stack; and the DU is provided with a physical (PHY) layer protocol stack. Embodiments of this disclosure do not limit the specific implementation of the access device 12.

A wireless connection may be established between the access device 12 and UE 11 through a wireless air interface. In different embodiments, the wireless air interface is a wireless air interface based on the 4G standard; alternatively, the wireless air interface is a wireless air interface based on the 5G standard, for example, a new air interface; alternatively, the wireless air interface may also be a wireless air interface based on a technical standard of a next-generation mobile communication network based on 5G.

XRM service requires the 5th Generation System (5GS) to comprehensively consider the quality of service (QOS) characteristics of relevant data flow of the service, for example, whether the guaranteed bit rate (GBR) data flow, guaranteed flow bit rate (GFBR), packet delay budget (PDB), and/or default maximum data burst volume (MDBV) and other parameters associated with delay can be satisfied and coordinated at the same time. The data flow of XRM service may involve the data flows of multiple XRM services of one UE, and/or the data flows of multiple UEs. The QoS authorization and execution of these multiple data flows are to be consistent to ensure the service quality of the XRM service.

As shown in FIG. 2, some embodiments of this disclosure provide an XRM service processing method, which is performed by a time-sensitive communication and time synchronization function (TSCTSF) and includes the followings.

In S1110, a session creation request is received from an application function (AF), where the session creation request includes a synchronization indication and an XRM group identifier.

In S1120, the synchronization indication and the XRM group identifier are sent to a policy control function (PCF).

In some embodiments, the synchronization indication and the XRM group identifier are parameters that the session creation request must carry.

In some scenarios, delay information and UEs Internet protocol (IP) address are optional parameters that can be carried in the session creation request. That is, in other embodiments, the session creation request may also include the delay information and/or the UEs IP address. At this time, the method further includes: sending the delay information and/or the UEs IP address to the PCF.

In short, the information carried in the session creation request can be used by the PCF to generate a policy control and charging (PCC) rule or activate a predefined PCC rule.

AF may be a device located in a mobile communication network provided by a communication operator. AF may be provided by an application operator. Specifically, the AF may include one or more application servers.

TSCTSF may be a core network element (also called core network device), and any network element that performs the forgoing operations can be called TSCTSF.

5GS provides time synchronization service, and TSCTSF may be an important network element that provides the time synchronization service.

For example, if AF is to create a session, involving multiple data flows, that has small delay difference requirement on the multiple data flows or is sensitive to the delay of the data flows, it will send a session creation request to TSCTSF. In this way, after receiving the session creation request from AF, TSCTSF can obtain, from the session creation request, the delay information and XRM group identifier of one or more data flows involved with the session requested to be created by AF.

The multiple data flows involved with the session requested to be created in some embodiments of the disclosure may be time sensitive communication (TSC) data flows. In this way, TSCTSF may operate the time synchronization service on the TSC data flows.

The synchronization indication carried in the session creation request can be used to indicate that the session currently requested to be created is a time-sensitive session. One or more data flows involved with this session are all TSC data flows, that is, these data flows are very sensitive to delay and very sensitive to the delay difference of multiple data flows.

After receiving the session creation request containing the synchronization indication, if the session creation request contains the synchronization indication, TSCTSF will provide time synchronization service for multiple data flows involved with the session (i.e., AF session) requested to be created by AF.

For example, after receiving the synchronization indication, TSCTSF may send the synchronization indication to PCF. After receiving the synchronization indication, PCF knows that the AF session currently requested to be created involves TSC data flows. If there are multiple data flows, when determining a strategy to control routing path, PCF may consider allowing the multiple data flows to use the same routing path as much as possible to reduce the transmission delay difference.

For example, since multiple data flows involved with the XDM group identifier are all TSC data flows, a same user plane function (UPF) can preferentially be used for transmission and/or monitoring.

Exemplarily, TSCTSF provides time synchronization service for one or more data flows of the session requested to be created by AF based on the delay information provided by AF or the delay information identified according to the XRM group identifier, so as to ensure the delay of one or more data flows involved with the session and/or the delay difference between multiple data flows.

The XRM group identifier is a group identifier of the XRM service involved with the session requested to be created. The XRM group identifier is used to identify multiple data flows within an XRM service group. Multiple data flows in an XRM group may belong to one UE or multiple UEs.

For example, the XRM group identifier may be related to a group of UEs participating in multiple data flow transmissions. The UE group may include one or more UEs. Therefore, the UEs IP address may also be used to identify the XRM service.

After receiving the delay information and the XRM group identifier and/or the UEs IP address, TSCTSF may send the delay information, and at least one of the XRM group identifier and the UEs IP address to PCF. PCF is a core network function (or core network device) that formulates and maintains various policies.

For example, after receiving the delay information and the XRM group identifier and/or UEs IP address, PCF may formulate a PCC rule.

After receiving the information sent by TSCTSF, PCF can dynamically generate a PCC rule or activate a predefined PCC rule. After the predefined PCC rule is activated, it is equivalent to the PCC rule taking effect, and the corresponding data flow can be scheduled and monitored according to the PCC rule.

In some embodiments, the session creation request further includes: delay information and/or UEs IP address. If the session creation request contains the delay information, it means that AF itself has provided the delay information for the session created by this request. Since the XRM service data flow(s) involved with the session created by this request of AF may involve a UE group, the UE group may have UEs IP addresses. A UE group includes one or more UEs.

S1120 may include: sending the synchronization indication and the XRM group identifier, as well as the delay information and/or the UEs IP address to PCF.

If the delay information is sent to PCF, PCF can generate the PCC rule or activate the predefined PCC rule based on the delay information received from TSCTSF.

In some embodiments, the method further includes:
calculating PDB based on the delay information.

After receiving the delay information, TSCTSF can determine the maximum tolerated delay of each data flow involved with the session requested to be created, and/or the maximum tolerated delay difference of the data flows involved with the session.

Based on the delay information, TSCTSF can calculate the PDB. For example, the TSCTSF determines the PDB of uplink data flow (i.e., uplink PDB) and/or the PDB of downlink data flow (i.e., downlink PDB) based on the delay information.

If TSCTSF calculates the PDB, it may send the PDB to PCF.

For example, if TSCTSF does not calculate the PDB by itself, it may directly send the delay information and the XRM group identifier to PCF, and PCF can calculate the PDB by itself. In some embodiments, TSCTSF may send all delay information obtained from the session creation request and/or at least the delay information used to calculate the PDB to the PCF.

In some embodiments, if TSCTSF calculates the PDB by itself, the PDB and the XRM group identifier may be provided to PCF. Alternatively, the PDB may also be sent to PCF along with the delay information and the XRM group identifier.

In other embodiments, TSCTSF does not calculate the PDB, so TSCTSF sends the delay information and XRM group identifier and/or UEs IP addresses as received to PCF.

In some embodiments, the delay information includes at least one of the following:
a round-trip delay;
an uplink delay;
a downlink delay;
a delay difference of data flow.

The round-trip delay here may be the sum of uplink delay and downlink delay.

The uplink delay may be the delay of data flow from UE to the network device (e.g., UPF).

The downlink delay may be the delay of data flow from the network device to UE.

The delay difference of data flow here may specifically be the delay difference of multiple data flows. For example, the delay difference of the multiple data flows may include: the delay difference of multiple uplink data flows involved with the same XRM group identifier and/or UEs IP address, and/or, the delay difference of multiple downlink data flows involved with the same XRM group identifier and/or UEs IP address.

In some embodiments, the session creation request further includes at least one of the following:
flow description;
QoS information and requirement;
an identifier of AF.

The flow description may include one or more information elements (IEs) describing the attribute information of data flow.

The QoS information and requirement can be used by a core network element to determine the maximum delay that each data flow can tolerate and/or the maximum delay difference that the data flow(s) can tolerate.

Exemplarily, the QOS information and requirement include at least one of the following:
a QoS parameter;
a QoS reference;
an alternative service requirement.

Exemplarily, the QoS parameter may include at least one of the following:
a requested 5GS delay;
a request period/cycle;
a requested maximum guaranteed bitrate (GB);
a requested maximum bitrate;
a flow direction, for example, one or more data flows involved with the AF may be an uplink data flow(s) and/or a downlink data flow(s), where the flow direction of uplink data flow is uplink and the flow direction of downlink data flow is downlink;
a burst size;
a burst arrival time at UE;
a burst arrival time at UPF;
a time domain;
a survival time of data flow.

The alternative service requirement may include at least one of the following parameters:
information provided by AF that helps determine independent QoS parameters;
an optional QoS-related parameter set, which includes one or more optional QoS parameters or QoS references.

Exemplarily, the QoS reference may also be used to determine any reference information that determines the QoS of data flow. In some embodiments, QoS may be part of the alternative service requirement.

The above are just examples of QoS information and requirement, and the specific implementation is not limited thereto.

In some embodiments, the PDB and the synchronization indication, the XRM group identifier and/or UEs IP addresses, and the delay information are included in the authorization creation or update request for being sent to PCF.

After receiving the authorization creation or update request, PCF may authenticate the AF session requested by AF. When the AF session is authorized, the session creation will continue. After the session creation is completed, one or more data flows involved with the AF session can be transmitted based on the created session.

For example, creating the AF session includes: allocating a session identifier, allocating transmission resources used by the session, and/or determining a routing path of one or more data flows involved with the session.

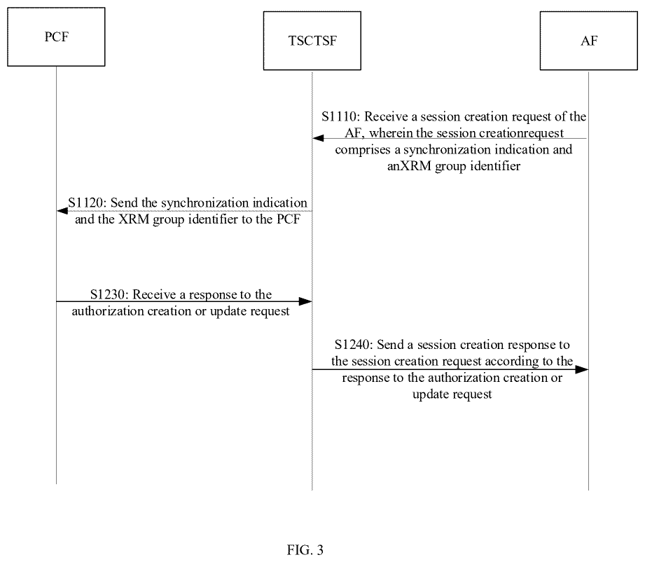

As shown in FIG. 3, some embodiments of this disclosure provide an XRM service processing method, which is performed by TSCTSF and includes the followings.

In S1210, a session creation request is received from AF, where the session creation request includes a synchronization indication and an XRM group identifier.

In S1220, an authorization creation or update request is sent to PCF, where the authorization creation or update request includes the synchronization indication and the XRM group identifier.

In S1230, a response to the authorization creation or update request is received.

In S1240, a session creation response to the session creation request is sent according to the response to the authorization creation or update request.

In some embodiments, the session creation request may also include: delay information and/or UEs IP address. If the session creation request contains delay information and/or UEs IP address, TSCTSF may send the delay information and/or UEs IP address received from AF, along with the synchronization indication and XRM group identifier, to PCF through the authorization creation or update request.

After receiving the session creation request from AF, TSCTSF sends the authorization creation or update request to PCF, and will receive a response returned by PCF. After receiving the response to the authorization creation or update request, TSCTSF may further send a session creation response to AF.

The sending of a session creation response to the session creation request based on the response to the authorization creation or update request may include:
sending to AF a session creation response indicating creating session when the response to the authorization creation or update request is an acceptance response; or, sending to AF a session creation response indicating not creating session when the response to the authorization creation or update request is a rejection response.

In some embodiments, the method further includes:
sending a subscription request to PCF, where the subscription request is used to request a subscription to an event report.

For example, the subscription request is used to request to subscribe to an event report containing resource allocation status and/or transmission delay.

For example, the subscription request is used for event subscription of resource allocation status changes of one or more data flows involved with the AF session; and/or event subscription of the delay of data flow.

The subscribed event will be returned to AF in the form of an event report when a corresponding event occurs.

In some embodiments, the method further includes:
receiving the event report sent by PCF; and
sending the event report to AF.

In some embodiments, the address of TSCTSF is pre-stored on the network exposure function (NEF), PCF or trusted AF.

If the address of TSCTSF is pre-stored on the AF that sends the session creation request, AF can communicate directly with TSCTSF. For example, if AF is recognized as a trusted device by a management device of the communication operator, the address of TSCTSF can be directly provided to AF.

Both NEF and PCF belong to network elements within the communication network provided by the communication operator. The address of TSCTSF can also be pre-stored on NEF. Accordingly, AF can forward the interaction information between itself and TSCTSF through NEF.

In addition, the address of TSCTSF can also be directly stored on PCF to facilitate direct communication between PCF and TSCTSF. Exemplarily, after PCF is discovered by TSCTSF based on the discovery function, TSCTSF provides its own address to PCF.

The address of TSCTSF may at least include: an IP address of TSCTSF.

In some embodiments, the address of TSCTSF may not be pre-stored (i.e., pre-configured) on NEF, PCF or AF. For example, NEF may determine, a data network and/or a network slice used by the session, the address of TSCTSF associated with the data network and/or the network slice.

For example, PCF or NEF can query the user data repository (UDR) for the address of TSCTSF.

The above are just examples, and the specific implementation is not limited to the forgoing examples.

In some embodiments, the subscription request includes: event reporting mode information.

Herein, a reporting mode of the event report indicated by the event reporting mode information includes at least one of the following:
an immediate reporting mode;
a periodic reporting mode;
a triggered reporting mode.

If it is the immediate reporting mode, after receiving the subscription request, PCF will immediately report the subscribed event report, where the event report includes: the delay and/or delay difference of data flow, and/or the resource allocation status of data flow, and the like.

In the periodic reporting mode, event reports of subscribed events will be sent to TSCTSF periodically, and then forwarded by TSCTSF to AF. If the periodic reporting mode is adopted, the PCF side may configure a timer for the periodic reporting mode. When the timer expires, the event report corresponding to the subscribed event will be submitted from PCF to TSCTSF.

In the triggered reporting mode, after the subscribed event is triggered, TSCTSF will receive the event report sent by PCF. For example, when the delay of data flow reaches the threshold, or the delay difference thereof reaches the threshold, TSCTSF will receive the event report submitted by PCF.

For example, the event reporting mode information may include an immediate reporting flag. If the immediate reporting flag is taken a preset value, it indicates that the reporting mode of the event report corresponding to the currently subscribed event is the immediate reporting mode. In another example, if the subscribed event includes periodic information of the periodic reporting mode, it indicates that AF subscribes to event reports that are reported periodically. Accordingly, the event reporting mode information may be implicitly indicated by the period information.

As another example, if the subscribed event includes a threshold or the like that triggers a subscribed event, it means that AF subscribes to event reports in the triggered reporting mode. Accordingly, the event reporting mode information may be implicitly indicated by the threshold.

Alternatively, the subscription request may include one or more bits carrying the event reporting mode.

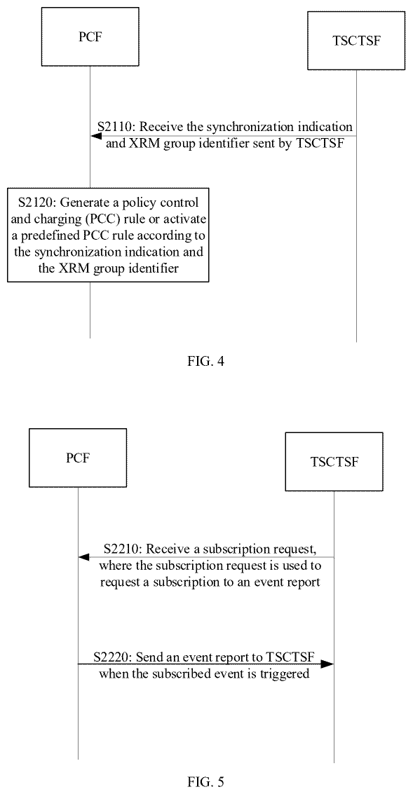

As shown in FIG. 4, some embodiments of this disclosure provide an information processing method, which is performed by PCF and includes the followings

In S2110, a synchronization indication and an XRM group identifier sent by TSCTSF are received.

In S2120, according to the synchronization indication and the XRM group identifier, a PCC rule is generated or a predefined PCC rule is activated.

PCF may receive from TSCTSF the synchronization indication and the XRM group identifier of data flows for which the PCC rule is to be generated or based on.

In some embodiments, S2110 may further include receiving at least one of delay information and UEs IP addresses upon receiving the synchronization indication and the XRM group identifier sent by TSCTSF.

S2120 may include: generating the PCC rule or activating the predefined PCC rule according to the synchronization indication and the XRM group identifier, and/or at least one of the delay information and the UEs IP addresses. For example, if PCF does not receive the delay information from TSCTSF, it can autonomously obtain the delay information based on the XRM group service identified by the XRM group identifier, and generate the PCC rule or activate the predefined PCC rule based on the autonomously obtained delay information.

The XRM group identifier is a group identifier of the XRM service involved with the request to create a session. The XRM group identifier is used to identify multiple data flows within an XRM service group. The multiple data flows in one XRM group may belong to one UE or multiple UEs.

After receiving the session creation request, if it is determined that the session is authorized to be created, a PCC rule will be generated or a predefined PCC rule will be activated for one or more data flows related to the session.

In some embodiments, the method further includes:
according to the synchronization indication and the delay information, generating the PCC rule or activating the predefined PCC rule for the data flows involved with the XRM group identifier and/or the UEs IP addresses.

In some embodiments of this disclosure, after receiving the delay information, PCF will generate the PCC rule or activate the predefined PCC rule for one or more data flows involved with the XRM group identifier based on the delay information, thereby controlling the communication resource allocation, routing path and/or charging condition, and the like of the data flow(s).

Exemplarily, the step of receiving the synchronization indication, the delay information, as well as the XRM group identifier and/or the UEs IP address sent by TSCTSF includes:
receiving an authorization creation or an update request including the synchronization indication, the delay information, as well as the XRM group identifier and/or the UEs IP address; and
sending to SCTSF a response corresponding to the authorization creation or the update request.

After receiving the authorization creation or the update request, no matter whether PCF determines to proceed with authorization/update or not, it will notify TSCTSF through the response (response message).

In some embodiments, the forgoing step performed according to the synchronization indication and the XRM group identifier includes:
when the authorization creation or update request further includes a PDB calculated by TSCTSF based on the delay information, generating the PCC rule or activating the predefined PCC rule according to the synchronization indication, the PDB calculated by TSCTSF, the XRM group identifier and/or the UEs IP address;
or,
when the authorization creation or update request does not include a PDB calculated by TSCTSF based on the delay information, calculating the PDB based on the delay information included in the authorization creation or update request, and generating the PCC rule or activating the predefined PCC rule according to the PDB calculated by PCF, the XRM group identifier, and/or the UEs IP address.

In some embodiments, TSCTSF may calculate PDB based on the delay information. In some embodiments, TSCTSF may not calculate PBD based on the delay information.

If TSCTSF calculates the PDB, PCF may receive the PDB sent by TSCTSF, so PCF can generate the PCC rule or activate the predefined PCC rule based on the PDB provided by TSCTSF. For example, based on the PBD provided by TSCTSF, PCF further determines burst data volume and the PDB applicable to each data flow to generate the PCC rule or activate the predefined PCC rule.

If TSCTSF does not calculate PDB, PCF will not receive PDB from TSCTSF. In this way, after receiving the delay information, PCF can calculate the PDB by itself based on the delay information, and generate the PCC rule or activate the predefined PCC rule based on the self-calculated PDB. For another example, PCF generates the PCC rule or activates the predefined PCC rule based on burst data volume and its own calculated PDB.

In some embodiments of this disclosure, after generating the PCC rule or activating the predefined PCC rule, PCC rule information related to SFM (Session Management Function) will be sent to SMF. SMF will create, modify and/or release sessions according to the PCC rule. For example, SMF will schedule session resources according to the PCC rule.

In some embodiments, after executing the PCC rule, PCF will send to the UPF the PCC rule information related to UPF, thereby facilitating UPF to perform user-plane data flow transmission according to the PCC policy information.

In some embodiments, based on the PDB included in the authorization creation or update request, determining the PCC rule for the UE involved with the XRM group identifier based on the delay information includes:
determining the PDB and burst data volume of the data flow based on the PDB and MDBV included in the authorization creation or update request; and
determining the PCC rule for the data flow involved with the XRM group identifier according to the burst data amount and the PDB of the data flow.

In some embodiments, the method further includes:
determining whether session creation is authorized.

For example, PCF may query the UE's subscription data based on the UE corresponding to the XRM group identifier, and determine whether to authorize creation of the session associated with the XRM group identifier.

As shown in FIG. 5, some embodiments of this disclosure provide an information processing method, which is performed by PCF. The method includes S2210: receiving a subscription request, where the subscription request is used to request a subscription to an event report.

For example, a subscription request is received from AF, and the subscription request can be used by AF to request a subscribed event report from the network device.

The event report may include but is not limited to: an event report on resource allocation status and/or an event report on delay.

For example, if AF subscribes to an event report on resource allocation status, when the resource allocation of one or more data flows of the AF session changes, AF can be notified through the event report. For example, the event report may indicate: a resource allocation report, a resource reclamation report, and/or a resource release report.

In some embodiments, the subscription request includes: event reporting mode information.

Herein, a reporting mode of the event report indicated by the event reporting mode information includes at least one of the following:
an immediate reporting mode;
a periodic reporting mode;
a triggered reporting mode.

If it is the immediate reporting mode, after receiving the subscription request, PCF will immediately report the subscribed event report, where the event report includes: the delay and/or delay difference of data flow, and/or the resource allocation status of data flow, and the like.

In the periodic reporting mode, event reports of subscribed events will be sent to TSCTSF periodically, and then forwarded by TSCTSF to AF. If the periodic reporting mode is adopted, the PCF side may configure a timer for the periodic reporting mode. When the timer expires, the event report corresponding to the subscribed event will be submitted from PCF to TSCTSF.

In the triggered reporting mode, after the subscribed event is triggered, TSCTSF will receive the event report sent by PCF. For example, when the delay of data flow reaches the threshold, or the delay difference thereof reaches the threshold, TSCTSF will receive the event report submitted by PCF.

For example, the event reporting mode information may include an immediate reporting flag. If the immediate reporting flag is taken a preset value, it indicates that the reporting mode of the event report corresponding to the currently subscribed event is the immediate reporting mode. In another example, if the subscribed event includes periodic information of the periodic reporting mode, it indicates that AF subscribes to event reports that are reported periodically. Accordingly, the event reporting mode information may be implicitly indicated by the period information.

As another example, if the subscribed event includes a threshold or the like that triggers a subscribed event, it means that AF subscribes to event reports in the triggered reporting mode. Accordingly, the event reporting mode information may be implicitly indicated by the threshold.

Alternatively, the subscription request may include one or more bits carrying the event reporting mode.

In some embodiments, the method further includes:

S2220: sending an event report to TSCTSF when the subscribed event is triggered.

In some embodiments, the method further includes:
when a subscribed event is triggered by a delay difference of data flow, sending the event report to TSCTSF according to the subscription request;
and/or,
when a subscribed event is triggered by a delay of data flow, sending the event report to TSCTSF according to the subscription request.

Changes in the delay difference of data flows may trigger the reporting of event reports. In this way, PCF can send an event report to TSCTSF according to the subscription request, and the event report can finally be forwarded to AF by TSCTSF.

When the delay of data flow fluctuates, it may also trigger the reporting of event reports. In this way, PCF can send an event report to TSCTSF according to the subscription request, and the event report will finally be forwarded to AF by TSCTSF.

The delay of data flow can be monitored and calculated by UPF. If AF requests to subscribe to event reports related to delay, PCF can perform subscription and the like to UPF.

Exemplarily, when the subscribed event is triggered by the delay difference of data flow, sending the event report to TSCTSF according to the subscription request includes:
subscribing, according to the subscription request, to UPF and/or NG-RAN for delays of data flows;
determining the delay difference according to the delay of data flows provided by UPF and/or NG-RAN; and
sending, when the subscribed event is triggered by the delay difference, the event report to TSCTSF.

In some embodiments of this disclosure, after receiving the subscription request, PCF can subscribe to UPF and/or NR-RAN for the delays of multiple data flows. In this way, PCF will receive the delays of multiple data flows provided by UPF and/or NR-RAN regularly or irregularly.

In this way, after receiving the delays of multiple data flows, PCF can calculate the delay difference between multiple data flows associated with the same identification information. It is further determined whether the time difference calculated by PCF triggers a subscribed event. If the subscribed event is triggered, an event report is sent to TSCTSF.

For example, when the delay difference between any two data flows among the multiple data flows involved with the same XRM group identifier is greater than the delay difference threshold, a subscribed event can be considered to be triggered. Accordingly, the fact of the subscribed event being triggered can be notified to TSCTSF through an event report.

For example, as the data flows involved with the same XRM group identifier may be transmitted by multiple UPFs and/or NR-RANs, a single UPF and/or a single NR-RAN may only monitor the delay of some data flows among the multiple data flows identified by the XRM group identifier. Accordingly, PCF can subscribe to the UPFs that transmits the multiple data flows involved with the XRM group identifier. After obtaining the delay of each data flow, PCF calculates the delay difference between multiple data flows. For example, PCF may calculate the maximum delay difference between the multiple data flows. If the maximum delay difference triggers a subscribed event, an event report can be sent to TSCTSF. The event report may include at least one of the following contents:
a trigger flag of subscribed event;
a flow ID of data flow that causes the subscribed event to be triggered;
a delay of data flow that causes the subscribed event to be triggered; and the like.

Specific implementation is not limited to the above examples of the event report.

In some embodiments, the event report may only include the trigger flag of the subscribed event. Accordingly, the event report is only used to notify TSCTSF that the subscribed event is triggered.

In other embodiments, when the subscribed event is triggered by the delay difference of data flow, sending the event report to TSCTSF according to the subscription request includes:
subscribing, according to the subscription request, to UP and/or NG-RAN for the delay difference of data flow; and
sending, when the subscribed event is triggered by the delay difference of data flow provided by UPF and/or NG-RAN, the event report to TSCTSF.

If multiple data flows associated with (or involved with) the XDM group identifier are scheduled to pass through the same UPF and/or the same NR-RAN due to synchronization requirements, accordingly, this UPF can monitor the delay of data flows associated with the XRM group identifier. Accordingly, UPF and/or NR-RAN can calculate the delay difference between multiple data flows based on the delays of multiple data flows monitored by itself.

In this case, PCF can directly subscribe to the delay difference from UPF and/or NR-RAN. In this way, PCF will receive the delay difference regularly or irregularly. After receiving the delay difference, PCF will determine whether the delay difference between multiple data flows triggers the subscribed event. If the subscribed event is triggered, PCF will send an event report to TSCTSF. Otherwise, no event report will be sent to TTSCTSF.

In some embodiments, when the subscribed event is triggered by the delay of data flow, sending the event report to the TSCTSF according to the subscription request includes:
subscribing, according to the subscription request, to UPF for the delay of data flow;
sending, when the subscribed event is triggered by the delay of data flow provided by the UPF and/or the NG-RAN, the event report to TSCTSF.

In some embodiments, PCF can also directly subscribe to UPF for the delay of data flow. When the delay of data flow triggers the subscribed event, the PCF will also send an event report to TSCTSF. Otherwise, the PCF will not send any event report to TSCTSF.

In an embodiment, when the subscribed event is triggered by the delay difference of data flow, sending the event report to TSCTSF according to the subscription request includes:
sending, according to the subscription request, a subscription request to UPF and/or NG-RAN, where the subscription request includes: a subscription request about triggering the subscribed event by the delay difference of data flow, and/or a subscription request about triggering the subscribed event by the delay of data flow;
receiving a notification message about triggering of the subscribed event sent by UPF; and
sending, according to the notification message, the event report to TSCTSF.

In an implementation scenario, if the XRM group identifier involves data flows to be transmitted by the same UPF, PCF may directly subscribe to UPF and/or NR-RAN for the event report, so UPF and/or NR-RAN can determine whether the subscribed event is triggered based on the delays of data flows monitored by itself and the delay difference between the data flows. If the subscribed event is triggered, the event is reported to PCF. In this way, PCF will receive the event report and send the event report to TSCTSF, and the event report can finally be sent to AF by TSCTSF.

In another implementation scenario, if the XRM group identifier only involves one data flow, PCF can also subscribe to UPF for the event report. Accordingly, UPF and/or NR-RAN transmits the data flow and monitors the delay thereof. When a subscribed event is triggered, UPF and/or NR-RAN will send an event report to PCF. Therefore, PCF will receive the event report and forward it to TSCTSF.

In yet another implementation scenario, if the XRM group identifier involves a data flow, and AF subscribes to events related to delay of the data flow, PCF can also subscribe to the corresponding UPF and/or NR-RAN for event reports related to delay of the data flow. Accordingly, if the delay of a certain data flow triggers a subscribed event, PCF will receive the event report sent by UPF. After receiving the event report, PCF will send the event report to TSCTSF, which will finally send it to AF.

Exemplarily, triggering of the subscribed event includes at least one of the following:
the delay of data flow is greater than or equal to a delay threshold corresponding to the subscribed event;
the delay difference of data flows is greater than or equal to a delay difference threshold corresponding to the subscribed event;
a timer for the subscribed event lapses;
an immediate reporting flag is received.

When the network delay does not exceed the maximum delay that can be tolerated by the data flow(s) involved with the XRM group identifier, the AF session requested by AF to create will be created. However, fluctuation may occur at the network status, for example, the delay of data flow may be greater than or equal to the delay threshold corresponding to the subscribed event during transmission of the data flow, it means that the delay of the data flow triggers the subscribed event.

If the XRM group identifier involves data flows, when the AF session is created, the network delay will not exceed the maximum delay difference that can be tolerated by the data flows. However, during the transmission, the delay difference of data flows will increase to be greater than or equal to the delay difference threshold of the subscribed event due to fluctuations in network status and the like, which means that the delay difference of the data flows triggers the subscription data.

For example, the timer for the subscribed event may be a periodic timer. If the timer expires, PCF will send an event report to TSCTSF. If the timer has not expired, PCF will not send any event report to TSCTSF.

If periodic event reports are subscribed, PCF will periodically send event reports to TSCTSF.

It is assumed that the delay threshold mentioned in the foregoing embodiments may be an alarm delay threshold determined based on the maximum tolerated delay or a stop delay threshold for stopping transmission of the data flow. In other embodiments, a reminder delay threshold may also be configured. For example, when the delay of data flow exceeds the alarm delay threshold and approaches the stop delay threshold, the delay of the data flow may shrink and return to below the alarm threshold due to network fluctuations.

Similarly, the delay difference threshold mentioned in the foregoing embodiments may be an alarm delay difference threshold determined based on the maximum tolerated delay difference or a stop delay difference threshold for stopping transmission of data flows. In other embodiments, a reminder delay difference threshold may also be configured. For example, when the actual delay difference of data flows exceeds the alarm delay difference threshold and approaches the stop delay difference threshold, the delay difference of the data flows may shrink and return to below the alarm threshold due to network fluctuations.

For example, if the subscription request contains an immediate reporting flag, it is equivalent to the subscribed event being triggered, so an event report is to be reported.

Therefore, triggering of the subscribed event may also include at least one of the following:
the delay of data flow is less than or equal to the reminder delay threshold;
the delay difference of data flows is less than or equal to the reminder delay difference threshold.

In some embodiments, the method further includes:
updating the PCC rule when the subscribed event is triggered.

In some embodiments, updating the PCC rule when the subscribed event is triggered includes:
increasing QoS authorized by the PCC rule when the subscribed event is triggered;
or,
reducing QoS authorized by the PCC rule when the subscribed event is triggered.

For example, when a subscribed event related to is are triggered, the QoS authorized by the PCC rule is to be increased or reduced.

For example, the PCC rule may define a 5G QOS identifier (5QI).

When a subscribed event related to delay is triggered and the delay of data flow decreases, the QoS authorized by the PCC rule can be improved by increasing the 5QI, thereby improving the QoS of data flow corresponding to the XRM group identifier.

When a subscribed event related to delay is triggered and the delay of data flow increases, the QoS authorized by the PCC rule can be reduced by decreasing the QoS (e.g., decreasing the 5QI), thereby preferably ensuring the transmission of data flow.

In some embodiments, the subscription request includes: event reporting mode information.

Herein, a reporting mode of the event report indicated by the event reporting mode information includes at least one of the following:
an immediate reporting mode;
a periodic reporting mode;
a triggered reporting mode.

If it is the immediate reporting mode, after receiving the subscription request, PCF will immediately report the subscribed event report, where the event report includes: the delay and/or delay difference of data flow, and/or the resource allocation status of data flow, and the like.

In the periodic reporting mode, event reports of subscribed events will be sent to TSCTSF periodically, and then forwarded by TSCTSF to AF. If the periodic reporting mode is adopted, the PCF side may configure a timer for the periodic reporting mode. When the timer expires, the event report corresponding to the subscribed event will be submitted from PCF to TSCTSF.

In the triggered reporting mode, after the subscribed event is triggered, TSCTSF will receive the event report sent by PCF. For example, when the delay of data flow reaches the threshold, or the delay difference thereof reaches the threshold, TSCTSF will receive the event report submitted by PCF.

For example, the event reporting mode information may include an immediate reporting flag. If the immediate reporting flag is taken a preset value, it indicates that the reporting mode of the event report corresponding to the currently subscribed event is the immediate reporting mode. In another example, if the subscribed event includes periodic information of the periodic reporting mode, it indicates that AF subscribes to event reports that are reported periodically. Accordingly, the event reporting mode information may be implicitly indicated by the period information.

As another example, if the subscribed event includes a threshold or the like that triggers a subscribed event, it means that AF subscribes to event reports in the triggered reporting mode. Accordingly, the event reporting mode information may be implicitly indicated by the threshold.

Alternatively, the subscription request may include one or more bits carrying the event reporting mode.

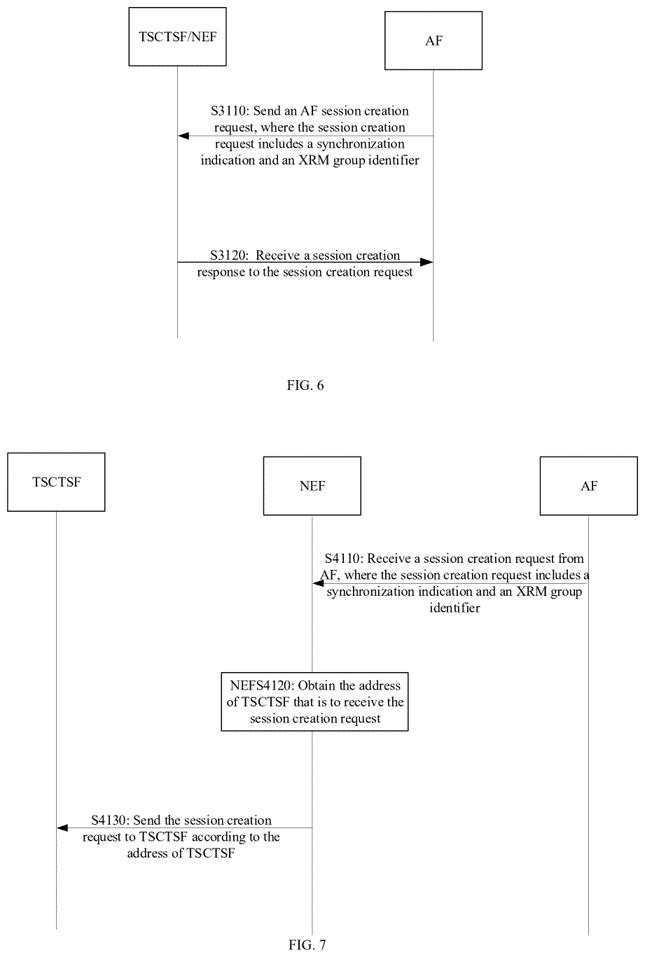

As shown in FIG. 6, some embodiments of this disclosure provide an information processing method, which is performed by AF and includes the followings.

In S3110, an AF session creation request is sent, where the session creation request includes a synchronization indication and an XRM group identifier.

In S3120, a session creation response corresponding to the session creation request is received.

In some embodiments of this disclosure, AF may be implemented by one or more servers. For example, AF may be a server that provides XRM services.

When AF is to perform transmission of data flows with UE, it may apply to the network side to create a session. Accordingly, it can send a session creation request to TSCTSF directly or through NEF.

In other embodiments, the session creation request further includes: delay information and/or UEs IP addresses.

The UE corresponding to the UEs IP address is UE that transmits the data flow of the XRM service; the XRM group identifier identifies an XRM group, and the XRM group includes: one or more XRM services that require data flow transmission.

In some embodiments, the delay information includes at least one of the following:
a round-trip delay;
an uplink delay;
a downlink delay;
a delay difference of data flow.

The round-trip delay here is the sum of uplink delay and downlink delay.

The uplink delay may be: the delay of data flow from UE to the network device (e.g., UPF).

The downlink delay may be: the delay of data flow from the network device to UE.

The delay difference of data flow here may be: the delay difference between data flows. The delay difference of data flow here may include: the delay difference between uplink data flows identified by the same XRM group identifier, and/or the delay difference between downlink data flows identified by the same XRM group identifier.

In an embodiment, the session creation request further includes at least one of the following:
synchronization indication;
flow description;
QoS information and requirement;
an identifier of AF.

The synchronization indication carried in the session creation request can be used to indicate that the session currently requested to be created is a time-sensitive session. One or more data flows involved with this session are all TSC data flows, that is, these data flows are very sensitive to delay and very sensitive to the delay difference of multiple data flows.

After receiving the session creation request containing the synchronization indication, if the session creation request contains the synchronization indication, TSCTSF will provide time synchronization service for multiple data flows involved with the session (i.e., AF session) requested to be created by AF.

For example, after receiving the synchronization indication, TSCTSF may send the synchronization indication to PCF. After receiving the synchronization indication, PCF knows that the AF session currently requested to be created involves TSC data flows. If there are multiple data flows, when determining a strategy to control routing path, PCF may consider allowing the multiple data flows to use the same routing path as much as possible to reduce the transmission delay difference.

For example, since multiple data flows involved with the XDM group identifier are all TSC data flows, a same UPF can preferentially be used for transmission and/or monitoring.

As another example, alternatively, the synchronization indication may not be transmitted to PCF. PCF directly determines whether the currently involved data flow is a TSC data flow based on the delay information. If it is a TSC data flow, an appropriate policy should also be executed based on such consideration that the time synchronization service is to provide for this data flow.

The flow description may include one or more IEs describing the attribute information of data flow.

The QoS information and requirement can be used by a core network element to determine the maximum delay that each data flow can tolerate and/or the maximum delay difference that the data flow(s) can tolerate.

Exemplarily, the QoS information and requirement include at least one of the following:
a QoS parameter;
a QoS reference;
an alternative service requirement.

Exemplarily, the QoS parameter may include at least one of the following:
a requested 5GS delay;
a request period/cycle;
a requested maximum GB;
a requested maximum bitrate;
a flow direction, for example, one or more data flows involved with the AF may be an uplink data flow(s) and/or a downlink data flow(s), where the flow direction of uplink data flow is uplink and the flow direction of downlink data flow is downlink;
a burst size;
a burst arrival time at UE;
a burst arrival time at UPF;
a time domain;
a survival time of data flow.

The alternative service requirement may include at least one of the following parameters:
information provided by AF that helps determine independent QoS parameters;
an optional QoS-related parameter set, which includes one or more optional QoS parameters or QoS references.

Exemplarily, the QoS reference may also be used to determine any reference information that determines the QoS of data flow. In some embodiments, QoS may be part of the alternative service requirement.

The above are just examples of QoS information and requirement, and the specific implementation is not limited thereto.

In an embodiment, the method further includes:
receiving a session creation response to the session creation request.

In some embodiments, the method further includes:
receiving a notification message sent by TSCTSF when the subscribed event is triggered.

If the subscribed event is triggered, TSCTSF will receive the notification message that the subscribed event is triggered. The notification message may include an event report.

The event report may include: an event report of resource allocation status and/or an event report related to delay.

The event report of resource allocation status may include: an event report related to the delay of data flow, and/or an event report related to the delay difference of data flows.

In this way, on the one hand, AF receives the event report and determines whether it needs to continue to send a session creation request of AF, or a delayed creation or update session request; on the other hand, AF can monitor the transmission status of AF session data flow in the network through the event report.

In some embodiments, sending the AF session creation request includes:
when an address of TSCTSF is stored in AF, sending the session creation request of AF to TSCTSF according to the address of TSCTSF.

In some embodiments of this disclosure, if the address of TSCTSF is stored in AF, it means that this AF is trusted by TSCTSF. In this way, AF can directly exchange information with TSCTSF based on the address of TSCTSF.

In other embodiments, sending the AF session creation request includes:
when the address of TSCTSF is not stored in AF, sending the session creation request of AF to NEF, where the session creation request is to be forwarded by NEF to TSCTSF.

If AF does not store the address of TSCTSF, AF may not be able to communicate directly with TSCTSF. Then AF sends the session creation request to NEF and receives the response and/or update message of TSCTSF forwarded through NEF.

As shown in FIG. 7, some embodiments of this disclosure provide an information processing method, which is performed by NEF and includes the followings.

In S4110, a session creation request is received from AF, where the session creation request includes a synchronization indication and an XRM group identifier.

In S4120, the address of TSCTSF that is to receive the session creation request is obtained.

In S4130, the session creation request is sent to TSCTSF according to the address of TSCTSF.

One or more data flows involved with the session requested by AF to create may be TSC data flows. The XRM group identifier is the identifier of XRM services involved with the session requested to create. The XRM group identifier may include an identifier of one or more XRM services. In short, the XRM group identifier can identify multiple data flows within an XRM service group.

For example, the XRM services involved with the XRM group identifier are to be transmitted by a UE group. This UE group may include one or more UEs. The UEs IP address may include IP addresses of the UEs.

In an embodiment, the session creation request further includes: delay information and/or UEs IP addresses.

In an embodiment, obtaining the address of TSCTSF that is to receive the session creation request includes:
querying the address of TSCTSF pre-stored by NEF;
or,
mapping an identifier of AF and/or the XRM group identifier and/or the UEs IP address included in the session creation request to a data network name (DNN) and/or a network slice identifier, and discovering the address of TSCTSF according to the mapping of the DNN and/or the network slice identifier.

NEF may receive the session creation request sent by AF. After receiving the session creation request, if the address of TSCTSF is locally stored in NEF, NEF may directly send the session creation request to TSCTSF according to the locally stored address of TSCTSF.

If NEF does not store the address of TSCTSF, an AF identifier and/or an XRM group identifier can be mapped to a DNN and/or a network slice identifier according to the AF identifier and/or the XRM group identifier as well as the mapping relationship information. The DNN and/or network slice identifier may further be mapped to the address of TSCTSF.

The mapping relationship information may indicate at least one of the following: mapping relationship between AF identifier(s) and DNN(s);
mapping relationship between AF identifier(s) and network slice identifier(s);
mapping relationship between XRM group identifier(s) and DNN(s);
mapping relationship between XRM group identifier(s) and network slice identifier(s);
mapping relationship between UEs IP address(es) and DNN(s);
mapping relationship between UEs IP address(es) and network slice identifier(s);
mapping relationship between DNN(s) and address(es) of TSCTSF;
mapping relationship between network slice identifier(s) and address(es) of TSCTSF.

The network slice identifier includes but is not limited to S-NSSAI (Single Network Slice Selection Assistance Information).

To um up, if NEF is not configured with the address of TSCTSF locally, it can determine the address of TSCTSF through the above manners, and exchange information between AF and TSCTSF.

In some embodiments, the method further includes:
receiving a session creation response corresponding to the session creation request;
and
sending the session creation response to the AF.

Since AF sends the session creation request to TSCTSF through NEF, NEF will receive the session creation response sent by TSCTSF and send the session creation response to AF.

In some embodiments, the method further includes:
receiving a notification message sent by TSCTSF when a subscribed event is triggered; and
sending the notification message to AF.

The notification message may include an event report, and the event report may be carried in the notification message and sent to AF. In this way, AF can know the transmission status of one or more data flows involved with the XRM service(s) in the network based on the notification message sent by NEF.

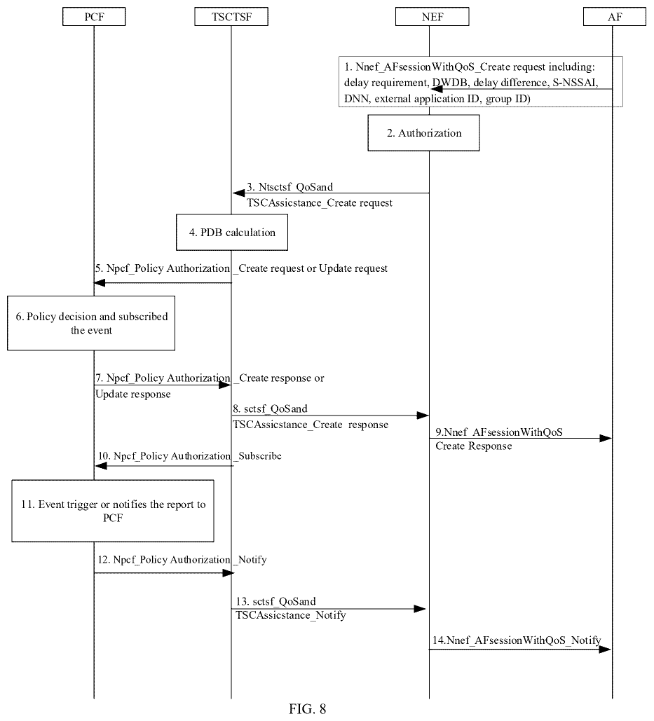

As shown in FIG. 8, some embodiments of this disclosure provide an XRM service processing method, which may include the followings.

1. AF sends an AF session creation request to TSCTSF. The AF session creation request provides synchronization indication, delay information, and XRM group identifier. The delay information includes but is not limited to: uplink delay, downlink delay, round-trip delay or delay difference. For example, AF may directly send the AF session creation request to TSCTSF, or send the AF session creation request to TSCSF through NEF.

2. TSCTSF calculates requested PDB based on the received synchronization indication, delay information, group ID, UE address, AF ID, flow description, and received QoS information and requirement. The group ID is one of the aforementioned XRM group identifiers, and the UE address may constitute one type of the UEs IP address.

TSCTSF can subscribe to synchronization-related delays from PCF, such as 5G end-to-end delay or delay difference, by triggering request of Npcf_PolicyAuthorization_Create or Npcf_PolicyAuthorization_Subscribe. The delay subscribed from PCF here may be the actual transmission delay of data flow.

The address of TSCTSF may be configured locally in NEF, PCF and/or a trusted AF, or discovered and selected through NRF (Network Repository Function). NEF determines DNN/and/or S-NSSAI by using the group ID and/or AF ID, and discover the address of TSCTSF from NRF by using DNN and/or S-NSSAI.

AF sends the session creation request of AF to TSCTSFF by using Nnef_AFsession_WithQoS_Create, so as to request to reserve resources for the AF session. The AF session creation request may include: synchronization indication, delay information, group ID, application ID, UE address, one or more data flow descriptions or external application identifiers, QoS reference, QoS parameter, alternative service requirement, DNN, S-NSSAI. The request may be sent to NEF and, then, sent by NEF to TSCTSF.

Alternatively, AF can directly send the AF session creation request to TSCTSF. For example, AF sends an AF session resource request, for example, through Nnef_AFsessionWithQoS_Create request to create an AF request. AF carries XRM service information in the request message, where the XRM service information includes synchronization indication, delay information, application ID, group ID, UE address, one or data flow descriptions, S-NSSAI and/or QoS parameter and other corresponding information. The group ID can be used to identify all data flows in the XRM service group. The delay information may include: uplink delay, downlink delay, round-trip delay, end-to-end delay and/or delay difference.

Optionally, in the AF session creation request, AF can provide the following separate QoS parameters: requested 5GS delay (optional), requested priority, requested GB, and requested maximum bitrate. The priority may be an optional parameter.

AF can also provide the following optional QoS parameters:
flow direction, burst size, burst arrival time of UE uplink or UPF downlink, periodicity, time domain, and survival time.

When the alternative service requirement is provided by an AF request formulated with independent QoS parameters, an optional set of QoS-related parameters may be provided.

2. NEF authorizes the AF session creation request.

3. NEF decides to call TSCTSF to interact with PCF based on the request, thereby triggering PCF to generate a PCC rule or activate a predefined PCC rule through TSCTSF. NEF includes the received synchronization indication, delay information, group ID, application ID, individual QoS parameter, QoS reference and other information into the QoS related parameter set in Ntsctsf_QoSandTSCAssistance_Create request message, and forwards the Ntsctsf_QoSandTSCAssistance_Create request message to TSCTSF. TSC assistance information can be used by TSCTSF to provide time synchronization services to data flows. Information content of the TSC assistance information can be shown in Table 1.

TABLE 1

| Assistance | |
|---|---|
| Information | Description |
| Flow Direction | Direction of TSC data flow, for example, uplink |
| | data flow or downlink data flow |
| Periodicity | It refers to the time period between start of two |
| | data bursts |
| Burst Arrival Time | The time when the first packet of the data burst |
| (optional | arrives at the ingress port of 5GS for a given |
| information) | flow direction (for the uplink data flow, the |
| | ingress port may be DS-TT; for the downlink |
| | data flow, the ingress port may be NW-TT) |
| Survival Time or | Duration of data burst (It refers to the time |
| Lifetime | period an application can survive without any |
| (optional | data burst) |
| information) | |
| Time Domain | The (g)PTP (point to point) domain of the TSC |
| (optional | flow |
| information) | |

DS-TT may be device-side TSN translator, where TSN is time sensitive network.

NW-TT may be network-side TSN translator.

If AF is trusted by the communication operator, AF can directly interact with TSCTSF by using the ntsctsf_qsandtscassistance_create request message, thereby requesting to reserve resources for the AF session.

The address of TSCTSF may be pre-configured locally in NEF, PCF and a trusted AF, or discovered and selected through NRF.

For example, each DNN and/or S-NSSAI is configured with one TSCTSF.

Alternatively, NEF determine DNN/S-NSSAI by using the group ID and/or AF identifier, and discovers TSCTSF from NRF by using DNN/S-NSSAI.

4. Optionally, TSCTSF calculates the requested PDB based on the received synchronization indication, delay information, group ID, UE address, AF identifier, one or more flow descriptions, and received QoS information and requirement.

5. TSCTSF is provided with the address of PCF to which the given UE is connected, where the given UE is associated with the data flow(s) involved with the XRM service(s). In this case, TSCTSF interacts with PCF by triggering Npcf_PolicyAuthorization_Create/Update request and providing the synchronization indication, delay information, group ID, UE address, AF identifier, flow description(s), QoS reference, QoS parameter and alternative service requirement.

If TSCTSF does not have the address of PCF to which the given UE is connected, where the given UE is associated with the data flow(s) involved with the XRM service(s), then TSCTSF discovers PCF and sends to the discovered PCF an Npcf_Policy Authorization_Create PCF request message including the synchronization indication, delay information, group ID, requested PDB, TSC assistance container as well as other received individual QoS and alternative QoS related parameter. For example, TSCTSF has a discovery function, and the discovery function may include discovering PCF through information interaction between TSCTSF and NRF.

TSCTSF can subscribe to synchronization-related delays from PCF by sending Npcf_PolicyAuthorization_Create or Npcf_PolicyAuthorization_Subscribe request.

TSCTSF may receive any of the following individual QoS parameters from NEF: flow direction, burst arrival time, period, time domain, and survival time.

TSCTSF determines the TSC assistance container and sends the TSC assistance container to PCF along with the requested PDB and other QoS parameters received in the Npcf_PolicyAuthorization_Create/Update request.

6. For the request received from TSCTSF in step S, PCF determines whether the request is authorized and notifies TSCTSF if the request is not authorized.

PCF is responsible for formulating policies and subscribing to event reports requested by AF or TSCTSF. For example, PCF subscribes to UPF for synchronization-related delays. For example, PCF triggers a subscription or receives a subscription from TSCTSF. PCF may trigger QoS monitoring of a specific data flow to obtain the end-to-end delay and calculate the delay difference of data flows.

For example, PCF initiates an SM policy association modification request to SMF (Session Management Function) to subscribe to the event. According to QoS measurements based on the QoS monitoring policy provided by PCF, SMF generates QoS monitoring configurations (if required) for UPF and RAN. Once receiving the notification, PCT may synchronize the notification and the delay related to synchronization to TSCTSF.

If the request is authorized, PCF obtains the required QoS parameters based on the information provided by TSCTSF, determines whether to allow this QoS flow based on PCF configuration, and notifies TSCTSF of the result. The QoS flow may be one or more data flows as described above associated with the XRM group identifier.

In addition, if alternative service requirement is provided, PCF derives an optional QoS parameter set from one or more QoS reference parameters, or determines an alternative QoS related parameter set based on the alternative service requirement and the requested PDB. The optional QoS parameter set or alternative QoS related parameter set here can be used by PCF to specify policies.

If PCF receives individual QoS parameters instead of a QoS reference, PCF may configure the PDB and MDBV based on the requested PDB and burst size received from TSCTSF. If the requested PDB is not provided, PCF may determine the PDB that matches the QoS reference. PCF may further configure the GBR and MBR of PCC rules (or PCC policies) based on the configurations, such as PDB, sent by TSCTSF. PCF may determine the priority of one or more data flows associated with the requested AF session by using the requested priority from AF. The QoS parameter values specified by TSCTSF will replace the default values of 5QI.

7. PCF interacts with TSCTSF by triggering the Npcf_PolicyAuthorization_Create/Update response, thereby informing TSCTSF whether the AF creation request is authorized. If the request is not authorized, or the required QoS is not allowed, PCF will respond to TSCTSF with a result value indicating the cause of failure.

8. TSCTSF sends a ntsctsf_qsandtscassistance_create session creation response to NEF, which may include: transaction reference ID and/or session creation result. The session creation result indicates whether the session creation request is authorized. If the session creation request is authorized, the session will be created by the network; otherwise the session will not be created by the network.

If AF is trusted by the operator, TSCTSF can directly send the ntsctsf_qsandtscassistance_create session creation response to AF.

9. NEF sends a Nnef_AFsessionWithQoS_Create session creation response to AF. The session creation response may include the transaction reference ID and the session creation result. The session creation result indicates whether the request is authorized. The session creation result indicates whether the session creation request is authorized. If the session creation request is authorized, the session will be created by the network; otherwise the session will not be created by the network.

10. TSCTSF sends a Npcf_PolicyAuthorization_Subscribe message to PCF to subscribe to the resource allocation status and/or subscribe to the synchronization-related delay.

11. A subscribed event is triggered, and an event report can be transmitted to PCF by UPF. For example, UPF triggers a notify message and reports measured information (e.g., end-to-end delay, delay difference) to PCF. For example, when UPF detects a delay reaching event, an event report will be triggered. For example, the delay or delay difference reaches a corresponding threshold, or the periodic timer expires (i.e., it detects that a subscribed event of a periodic subscription is triggered).

If PCF receives subscription for delay difference or end-to-end delay, PCF may send these delay-related event reports to TSCTSF. For example, if PCF finds that the delay difference reaches the delay difference threshold provided by AF, PCF notifies TSCTSF that a subscribed event is triggered.

Based on the notification of UPF, PCF can adjust the relevant PCC rules for one or more data flows, for example, downgrade or upgrade the relevant QoS authorization.

12. When a subscribed event is triggered, for example, when a threshold of end-to-end delay or delay difference is reached, or when a periodic timer expires, PCF sends an Npcf_PolicyAuthorization_Notify message to TSCTSF to notify that the subscribed event is triggered. The specific notification of subscribed event can be as described in step 11.

13. TSCTSF sends Ntsctsf_QoSandTSCAssistance_Notify message with the event report of PCF to NEF.

If AF is trusted by the operator, TSCTSF may directly send the Ntsctsf_QoSandTSCAssistance_Notify message to AF.

14. NEF sends the Nnef_AFsessionWithQoS_Notify message to AF, carrying the event report provided by PCF.

To revoke the AF creation request, AF can send a Nnef_AFsessionWithQoS_Revoke request to NEF. NEF authorizes the revocation request and triggers Ntsctsf_QoSandTSCAssistance_Delete/Unsubscribe and/or Npcf_PolicyAuthorization_Delete and Npcf_PolicyAuthorization_Unsubscribe operations on the AF creation request.

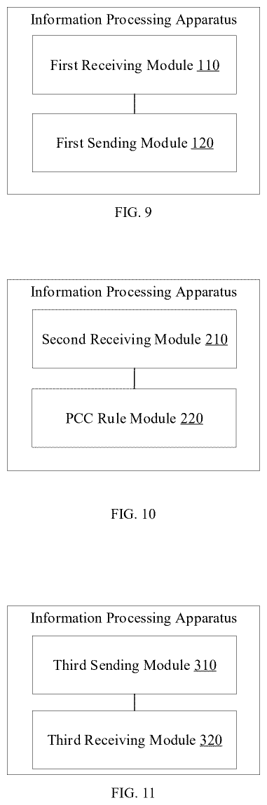

As shown in FIG. 9, some embodiments of this disclosure provide an XRM service processing apparatus, where the apparatus includes:
a first receiving module 110, configured to receive a session creation request from AF, where the session creation request includes a synchronization indication and an XRM group identifier or UEs IP address; and
a first sending module 120, configured to send the synchronization indication and the XRM group identifier and/or the UEs IP address to PCF.

This apparatus may be included in TSCTSF.

In some embodiments, the first receiving module 110 and the first sending module 120 may be program modules. After the program modules are executed by a processor, the forgoing operations can be implemented.

In some embodiments, the first receiving module 110 and the first sending module 120 may be software and hardware combined modules, which may include a programmable array, and the programmable array includes, but is not limited to, a field programmable array and/or a complex programmable array.

In some other embodiments, the first receiving module 110 and the first sending module 120 may be pure hardware modules, which are not limited to application specific integrated circuits.

In some embodiments, the synchronization indication and the XRM group identifier are used for PCF to generate a PCC rule or activate a predefined PCC rule.

In some embodiments, the session creation request further includes: delay information and/or UEs IP address.

The first sending module 120 is further configured to send the delay information and/or the UEs IP address to PCF.

In some embodiments, the apparatus further includes:
a calculation module, configured to calculate PDB based on the delay information.

The first sending module 120 is configured to send the PDB to PCF.

In some embodiments, the delay information includes at least one of the following:
a round-trip delay;
an uplink delay;
a downlink delay;
a delay difference of data flow.

In some embodiments, the session creation request further includes at least one of the following:
flow description;
QoS information and requirement;
an identifier of AF.

In some embodiments, the QoS information and requirement include at least one of the following:
a QoS parameter;
a QoS reference;
an alternative service requirement.

In some embodiments, the PDB and the synchronization indication, the XRM group identifier and/or the UEs IP address, and the delay information are included in authorization creation or update request to be sent to PCF.

In some embodiments, the first receiving module 110 is further configured to receive a response to the authorization creation or update request.

The first sending module 120 is further configured to send, according to the response to the authorization creation or update request, a session creation response corresponding to the session creation request.

In some embodiments, the first sending module 120 is further configured to send a subscription request to PCF, where the subscription request is used to request a subscription to an event report.

In some embodiments, the first receiving module 110 is further configured to receive the event report sent by PCF.

The first sending module 120 is further configured to send the event report to AF, where the notification message includes the event report.

In some embodiments, an address of TSCTSF is pre-stored on NEF, PCF or a trusted AF.

In an embodiment, the subscription request includes event reporting mode information.

Herein, the reporting modes of the event report indicated by the event reporting mode information may include at least one of the following:
an immediate reporting mode;
a periodic reporting mode;
a triggered reporting mode.

As shown in FIG. 10, some embodiments of this disclosure provide an information processing apparatus, which includes:
a second receiving module 210, configured to receive a synchronization indication and an XRM group identifier sent by TSCTSF; and
a PCC rule module 220, configured to generate a PCC rule or activate a predefined PCC rule according to the synchronization indication and the XRM group identifier.

This apparatus may be included in the PCF.

In some embodiments, the second receiving module 210 and the PCC rule module 220 may be program modules. After the program modules are executed by a processor, the forgoing operations can be implemented.

In some embodiments, the second receiving module 210 and the PCC rule module 220 may be software and hardware combined modules, which may include a programmable array, and the programmable array includes, but is not limited to, a field programmable array and/or a complex programmable array.

In some embodiments, the second receiving module 210 and the PCC rule module 220 may be pure hardware modules, which are not limited to application specific integrated circuits.

In some embodiments, the second receiving module 210 is configured to receive the synchronization indication and the XRM group identifier sent by TSCTSF, as well as delay information and/or UEs IP address.

In some embodiments, the apparatus further includes that:
the PCC rule module is configured to generate a PCC rule or activate a predefined PCC rule for the data flow(s) involved with the XRM group identifier and/or the UEs IP address according to the synchronization indication and the delay information.

In some embodiments, the second receiving module 210 is configured to receive an authorization creation or update request including the synchronization indication, the delay information, and the XRM group identifier and/or the UEs IP address.

The apparatus may further include:
a second sending module, configured to send a response to the authorization creation or update request to TSCTSF.

In some embodiments, the PCC rule module is configured to, when the authorization creation or update request further includes a PDB calculated by TSCTSF based on the delay information, generate the PCC rule or activate the predefined PCC rule according to the synchronization indication, the PDB, the XRM group identifier, and/or the UEs IP address.

Alternatively, it is configured to, when the authorization creation or update request does not include the PDB calculated by TSCTSF based on the delay information, calculate the PDB based on the delay information included in the authorization creation or update request, and generate the PCC rule or activate the predefined PCC rule according to the PDB calculated by PCF, the XRM group identifier and/or the UEs IP address.

In some embodiments, the PCC rule module is configured to determine a burst data volume and a PDB of data flow according to an MDBV and the PDB included in the authorization creation or update request; and generate the PCC rule or activate the predefined PCC rule according to the burst data volume and the PDB of data flow, the XRM group identifier and/or the UEs IP address.

In some embodiments, the apparatus further includes:
an authorization module, configured to determine whether the session is authorized to be created.

In some embodiments, the second receiving module 210 is further configured to receive a subscription request, where the subscription request is used to request a subscription to an event report.

In some embodiments, the second sending module is further configured to, when a subscribed event is triggered by a delay difference of data flow, send the event report to TSCTSF according to the subscription request; and/or configured to, when a subscribed event is triggered by a delay of data flow, send the event report to TSCTSF according to the subscription request.

In some embodiments, the second sending module is further configured to subscribe, according to the subscription request, to UPF for a delay of data flow.

A delay difference module is configured to determine the delay difference according to the delay of data flows provided by UPF.

The second sending module is further configured to send, when the subscribed event is triggered by the delay difference, the event report to TSCTSF.

In some embodiments, the second sending module is further configured to subscribe, according to the subscription request, to UPF for the delay difference of data flow; and send, when the subscribed event is triggered by the delay difference of data flow provided by UPF, the event report to TSCTSF.

In some embodiments, the second sending module is configured to subscribe, according to the subscription request, to UPF for the delay of data flow; and send, when the subscribed event is triggered by the delay of data flow provided by UPF, the event report to TSCTSF.

In some embodiments, the second sending module is further configured to send, according to the subscription request, a subscription request to UPF, where the subscription request includes: a subscription request about triggering the subscribed event by the delay difference of data flow; and/or a subscription request about triggering the subscribed event by the delay of data flow.

The second receiving module 210 is further configured to receive a notification message about triggering of the subscribed event sent by UPF.

The second sending module is further configured to send the event report to TSCTSF according to the notification message.

In some embodiments, triggering of the subscribed event includes at least one of the following:
the delay of data flow is greater than or equal to a delay threshold corresponding to the subscribed event;
the delay difference of data flow is greater than or equal to a delay difference threshold corresponding to the subscribed event;
a timer for the subscribed event lapses;
an immediate reporting flag is received.

In an embodiment, the subscription request includes: event reporting mode information.

Herein, the reporting mode of the event report indicated by the event reporting mode information includes at least one of the following:
an immediate reporting mode;
a periodic reporting mode;
a triggered reporting mode.

In some embodiments, the apparatus further includes:
an update module, configured to update the PCC rule when the subscribed event is triggered.

In some embodiments, the update module is configured to increase QoS authorized by the PCC rule when the subscribed event is triggered; or, reduce QoS authorized by the PCC rule when the subscribed event is triggered.

As shown in FIG. 11, some embodiments of this disclosure provide an information processing apparatus, which includes:
a third sending module 310, configured to send a session creation request of AF, where the session creation request includes a synchronization indication and an XRM group identifier; and
a third receiving module 320, configured to receive a session creation response corresponding to the session creation request.

This apparatus may be included in PCF.

In some embodiments, the third sending module 310 may be a program module. After the program module is executed by a processor, the forgoing operations can be implemented.

In some embodiments, the third sending module 310 may be a combined software and hardware module, which may include a programmable array, and the programmable array includes, but is not limited to, a field programmable array and/or a complex programmable array.

In some other embodiments, the third sending module 310 may be a pure hardware module, which is not limited to an application specific integrated circuit.

In an embodiment, the session creation request further includes: delay information and/or UEs IP addresses.

In some embodiments, the delay information includes at least one of the following:
a round-trip delay;
an uplink delay;
a downlink delay;
a delay difference of data flow.

In some embodiments, the session creation request further includes at least one of the following:
synchronization indication;
flow description;
QoS information and requirement;
an identifier of AF.

In some embodiments, the QoS information and requirement include at least one of the following:
a QoS parameter;
a QoS reference;
an alternative service requirement.

In some embodiments, the third receiving module is further configured to receive a notification message sent by TSCTSF when a subscribed event is triggered.

In some embodiments, the third sending module 310 is further configured to, when an address of TSCTSF is stored in AF, send the session creation request of AF to TSCTSF according to the address of TSCTSF.

In some embodiments, the third sending module 310 is further configured to, when an address of TSCTSF is not stored in AF, send the session creation request of AF to NEF. The session creation request is to be forwarded by NEF to TSCTSF

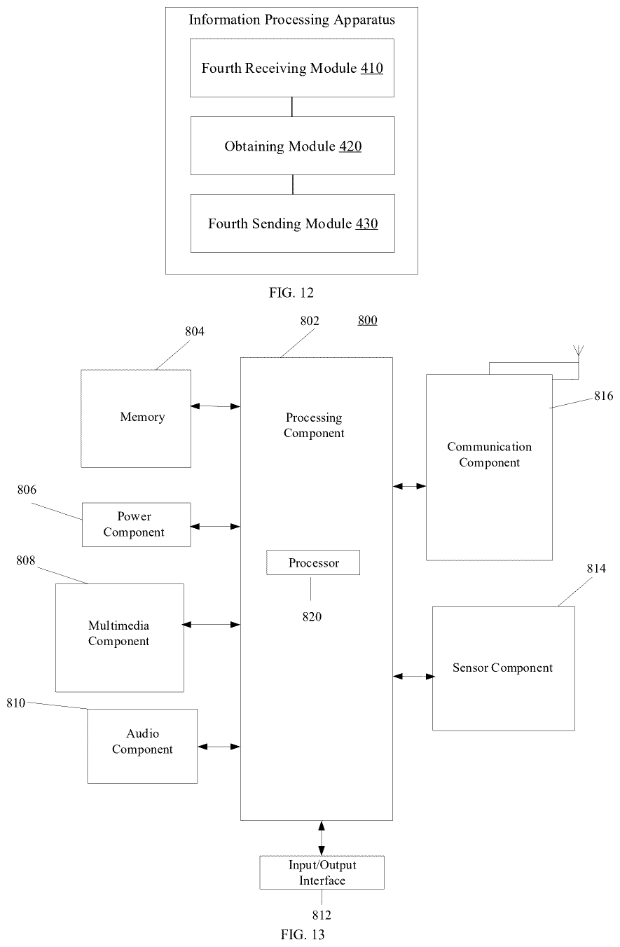

As shown in FIG. 12, some embodiments of this disclosure provide an information processing apparatus, which includes:
a fourth receiving module 410, configured to receive a session creation request from AF, where the session creation request includes a synchronization indication and an XRM group identifier;
an obtaining module 420, configured to obtain the address of TSCTSF that is to receive the session creation request; and
a fourth sending module 430, configured to send the session creation request to TSCTSF according to the address of TSCTSF.

The information processing apparatus may be included in NEF.

In some embodiments, the fourth receiving module 410, the obtaining module 420 and the fourth sending module 430 may be program modules. After the program modules are executed by a processor, the forgoing operations can be implemented.

In some embodiments, the fourth receiving module 410, the obtaining module 420 and the fourth sending module 430 may be software and hardware combined modules, which may include a programmable array, and the programmable array includes, but is not limited to, a field programmable array and/or a complex programmable array.

In some embodiments, the fourth receiving module 410, the obtaining module 420 and the fourth sending module 430 may be pure hardware modules, which are not limited to application specific integrated circuits.

In an embodiment, the session creation request further includes delay information and/or UEs IP address.

In some embodiments, the obtaining module 420 is configured to query the address of TSCTSF pre-stored by NEF; or, map an identifier of AF and/or the XRM group identifier and/or the UEs IP address included in the session creation request to a DNN and/or a network slice identifier, and discover the address of TSCTSF according to the mapping of the DNN and/or the network slice identifier.

In some embodiments, the fourth receiving module 410 is configured to receive a session creation response of the session creation request.

The fourth sending module 430 is further configured to send the session creation response to AF.

In some embodiments, the fourth receiving module 410 is configured to receive the notification message sent by TSCTSF when the subscribed event is triggered.

The fourth sending module 430 is configured to send the notification message to AF.

Some embodiments of this disclosure provide a communication device, including:
a memory, configured to store instructions executable by the processor; and
a processor, connected to the memory respectively;
the processor is configured to perform the information processing method according to any of the foregoing technical solutions.

The processor may include various types of storage medium, which may be a non-transitory computer storage medium that can continue to store information stored thereon after the communication device is powered off.

Here, the communication device includes a UE or a network element, where the network element may be any one of the forgoing first to fourth network elements.

The processor may be connected to the memory through a bus or the like, and configured to read an executable program stored on the memory, so as to implement, for example, at least one of the methods shown in FIG. 2 to FIG. 8.

FIG. 13 is a block diagram showing a UE 800 according to some embodiments. For example, the UE 800 may be a mobile phone, a computer, a digital broadcast terminal, a messaging device, a game console, a tablet device, a medical device, a fitness device, a personal digital assistant, and the like.

Referring to FIG. 13, the UE 800 may include one or more of the following components: processing component 802, memory 804, power component 806, multimedia component 808, audio component 810, input/output (I/O) interface 812, sensor component 814, and communication component 816.

The processing component 802 generally controls the overall operation of the UE 800, such as operations associated with display, phone calls, data communications, camera operations, and recording operations. The processing component 802 may include one or more processors 820 to execute instructions to perform all or some of the steps of the methods described above. Additionally, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support operation at the UE 800. Examples of such data include instructions, contact data, phonebook data, messages, pictures, videos, and the like for any application or method operating on the UE 800. The memory 804 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 806 provides power to various components of the UE 800. The power components 806 may include a power management system, one or more power sources, and other components associated with generating, managing, and distributing power to the UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 808 includes a front camera and/or a rear camera. When the UE 800 is in an operation mode, such as a shooting mode or a video mode, the front camera and/or the rear camera may receive external multimedia data. Each of the front and rear cameras may be a fixed optical lens system or have focal length and optical zoom capability.

The audio component 810 is configured to output and/or input audio signals. For example, the audio component 810 includes a microphone (MIC) that is configured to receive external audio signals when the UE 800 is in operating modes, such as calling mode, recording mode, and voice recognition mode. The received audio signal may be further stored in the memory 804 or transmitted via the communication component 816. In some embodiments, the audio component 810 also includes a speaker for outputting audio signals.

The I/O interface 812 provides an interface between the processing component 802 and a peripheral interface module, which may be a keyboard, a click wheel, a button, or the like. These buttons may include, but are not limited to: home button, volume buttons, start button, and lock button.

The sensor assembly 814 includes one or more sensors for providing status assessments of various aspects of the UE 800. For example, the sensor assembly 814 can detect the open/closed state of the UE 800, the relative positioning of components, such as the display and keypad of the UE 800. The sensor assembly 814 can also detect a change in the position of the UE 800 or a component of the UE 800, the presence or absence of user contact with the UE 800, the orientation or acceleration/deceleration of the UE 800, and the temperature change of the UE 800. The sensor assembly 814 may include a proximity sensor configured to detect the presence of nearby objects in the absence of any physical contact. The sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access wireless networks based on communication standards, such as WiFi, 2G or 3G, or a combination thereof. In some embodiments, the communication component 816 receives broadcast signals or broadcast related information from an external broadcast management system via a broadcast channel. In some embodiments, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the UE 800 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the forgoing methods.

In some embodiments, there is also provided a non-transitory computer-readable storage medium including instructions, such as the memory 804 including instructions, executable by the processor 820 of the UE 800 to perform the method described above. For example, the non-transitory computer-readable storage medium may be ROM, random access memory (RAM), CD-ROM, magnetic tape, floppy disk, optical data storage device, and the like.

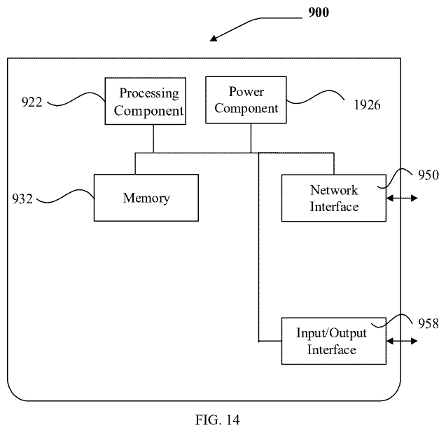

As shown in FIG. 14, it shows a structure of an access device according to some embodiments. For example, the communication device 900 may be provided as a network device, which may be the various network element such as the access network element and/or network function as described above.

Referring to FIG. 14, the communication device 900 includes a processing component 922, which further includes one or more processors; and a memory resource represented by memory 932 for storing instructions executable by the processing component 922, such as application programs. The application program stored in memory 932 may include one or more modules each corresponding to a set of instructions. In addition, the processing component 922 is configured to execute instructions to perform the forgoing methods, for example, the method as shown in any one of FIG. 2 to FIG. 8.

The communication device 900 may also include a power component 926 configured to perform power management of the communication device 900, a wired or wireless network interface 950 configured to connect the communication device 900 to a network, and an input-output (I/O) interface 958. The communication device 900 can operate based on an operating system stored in the memory 932, such as Windows Server™, Mac OS X™, Unix™, Linux™, FreeBSD™ or the like.

Other embodiments of this disclosure will be readily apparent to those skilled in the art from consideration of the specification and practice of the invention disclosed herein. This application is intended to cover any modification, use or adaptation of this disclosure, and these modifications, uses or adaptations follow the general principles of this disclosure and include common knowledge or conventional technical means in the art, which are not disclosed in this disclosure. The specification and examples are to be considered exemplary only, with a true scope and spirit of the disclosure being indicated by the following claims.

It should be understood that this disclosure is not limited to the precise constructions which have been described above and shown in the drawings, and various modifications and changes may be made without departing from the scope thereof. The scope of this disclosure is limited only by the scope of the appended claims.

1. An extended reality and media (XRM) service processing method, being performed by a time-sensitive communication and time synchronization function (TSCTSF) and comprising:
receiving a session creation request from an application function (AF), wherein the session creation request comprises a synchronization indication and an XRM group identifier; and
sending the synchronization indication and the XRM group identifier to a policy control function (PCF).

2. The method according to claim 1, wherein the session creation request further comprises at least one of: delay information or a user equipments (UEs) Internet protocol (IP) address; and
the method further comprises:
sending the at least one of the delay information or the UEs IP address to the PCF.

3. The method according to claim 2, further comprising:
calculating a packet delay budget (PDB) according to the delay information; and
sending the PDB to the PCF.

4. The method according to claim 2, wherein the delay information comprises at least one of:
a round-trip delay;
an uplink delay;
a downlink delay; or
a delay difference of data flow.

5. The method according to claim 1, wherein the session creation request further comprises at least one of:
flow description;
quality of service (QOS) information and requirement, comprising at least one of a QoS parameter, a QoS reference, or an alternative service requirement; or
an identifier of the AF.

6. (canceled)

7. The method according to claim 3, wherein the PDB and the synchronization indication, and the XRM group identifier and/or the UEs IP address and the delay information are included in authorization creation or update request to be sent to the PCF, and
the method further comprises:
receiving a response to the authorization creation or update request; and
sending, according to the response to the authorization creation or update request, a session creation response corresponding to the session creation request.

8. (canceled)

9. The method according to claim 1, further comprising:
sending a subscription request to the PCF, wherein the subscription request is used for requesting a subscription to an event report;
receiving the event report sent by the PCF; and
sending the event report to the AF.

10. (canceled)

11. The method according to claim 1, wherein an address of the TSCTSF is pre-stored on a network exposure function (NEF), the PCF or a trusted AF.

12. An information processing method, being performed by a policy control function (PCF) and comprising:
receiving a synchronization indication and an extended reality and media (XRM) group identifier sent by a time-sensitive communication and time synchronization function (TSCTSF); and
generating a policy control and charging (PCC) rule or activating a predefined PCC rule according to the synchronization indication and the XRM group identifier.

13. The method according to claim 12, wherein receiving the synchronization indication and the XRM group identifier sent by the TSCTSF comprises:
receiving the synchronization indication and the XRM group identifier, as well as at least one of delay information or a user equipments (UEs) Internet protocol (IP) address sent by the TSCTSF.

14. The method according to claim 13, wherein receiving the synchronization indication and the XRM group identifier, as well as the at least one of the delay information or the UEs IP address sent by the TSCTSF comprises:
receiving authorization creation or update request including the synchronization indication, the delay information and at least one of the XRM group identifier or the UEs IP address; and
sending a response corresponding to the authorization creation or update request to the TSCTSF.

15. The method according to claim 14, wherein generating the PCC rule or activating the predefined PCC rule according to the synchronization indication and the XRM group identifier comprises:
when the authorization creation or update request further includes a packet delay budget (PDB) calculated by the TSCTSF based on the delay information, generating the PCC rule or activating the predefined PCC rule according to the synchronization indication, the PDB, and the at least one of the XRM group identifier or the UEs IP address;
or,
when the authorization creation or update request does not include a PDB calculated by the TSCTSF based on the delay information, calculating the PDB based on the delay information included in the authorization creation or update request, and generating the PCC rule or activating the predefined PCC rule according to the PDB calculated by the PCF, and the at least one of the XRM group identifier or the UEs IP address.

16. The method according to claim 15, wherein generating the PCC rule or activating the predefined PCC rule according to the synchronization indication, the PDB, and the at least one of the XRM group identifier or the UEs IP address comprises:
determining a burst data volume and a PDB of data flow according to a maximum data burst volume (MDBV) and the PDB included in the authorization creation or update request; and
generating the PCC rule or activating the predefined PCC rule according to the burst data volume and the PDB of data flow, and the at least one of the XRM group identifier or the UEs IP address.

17. The method according to claim 14, further comprising:
determining whether to authorize session creation.

18. The method according to claim 12, further comprising:
receiving a subscription request, wherein the subscription request is used for requesting a subscription to an event report; and
when a subscribed event is triggered, sending the event report to the TSCTSF according to the subscription request.

19. (canceled)

20. The method according to claim 18, further comprising at least one of:
in response to the subscribed event being triggered by a delay difference of data flow, sending the event report to the TSCTSF according to the subscription request comprises:
subscribing, according to the subscription request, to a user plane function (UPF) or a radio access network (NG-RAN) for a delay of data flow;
determining the delay difference according to the delay of data flow provided by the UPF or the NG-RAN; and
sending, when the subscribed event is triggered by the delay difference, the event report to the TSCTSF,
in response to the subscribed event being triggered by the delay difference of data flow, sending the event report to the TSCTSF according to the subscription request comprises:
subscribing, according to the subscription request, to a user plane function (UPF) or a radio access network (NG-RAN) for the delay difference of data flow; and
sending, when the subscribed event is triggered by the delay difference of data flow provided by the UPF or the NG-RAN, the event report to the TSCTSF,
in response to the subscribed event being triggered by a delay of data flow, sending the event report to the TSCTSF according to the subscription request comprises:
subscribing, according to the subscription request, to a user plane function (UPF) or a radio access network (NG-RAN) for the delay of data flow;
sending, when the subscribed event is triggered by the delay of data flow provided by the UPF or the NG-RAN, the event report to the TSCTSF,
in response to the subscribed event being triggered by the delay difference of data flow, sending the event report to the TSCTSF according to the subscription request comprises:
sending, according to the subscription request, a subscription request to a user plane function (UPF) or a radio access network (NG-RAN), wherein the subscription request includes: a subscription request about triggering the subscribed event by the delay difference of data flow; or a subscription request about triggering the subscribed event by the delay of data flow;
receiving a notification message about triggering of the subscribed event sent by the UPF or the NG-RAN; and
sending, according to the notification message, the event report to the TSCTSF.

21.-23. (canceled)

24. The method according to claim 18, wherein triggering of the subscribed event comprises at least one of:
a delay of data flow is greater than or equal to a delay threshold corresponding to the subscribed event;
a delay difference of data flow is greater than or equal to a delay difference threshold corresponding to the subscribed event;
a timer for the subscribed event lapses;
an immediate reporting flag is received.

25. The method according to claim 18, wherein the subscription request comprises event reporting mode information; and
wherein a reporting mode of the event report indicated by the event reporting mode information comprises at least one of:
an immediate reporting mode;
a periodic reporting mode; or
a triggered reporting mode.

26.-46. (canceled)

47. A time-sensitive communication and time synchronization function (TSCTSF) device, comprising a processor, a transceiver, a memory, and an executable program stored in the memory and able to be executable by the processor, wherein the processor, upon running the executable program, is configured to:
receive a session creation request from an application function (AF), wherein the session creation request comprises a synchronization indication and an XRM group identifier; and
sending the synchronization indication and the XRM group identifier to a policy control function (PCF).

48. A communication device, comprising a processor, a transceiver, a memory, and an executable program stored in the memory and able to be executable by the processor, wherein the processor, upon running the executable program, is configured to implement the method according to claim 12.
